(19) United States
(12) Patent Application Publication
(10) Pub. No.: US 2025/0376877 A1
(43) Pub. Date: Dec. 11, 2025

(54) CLOSURE LATCH ASSEMBLY WITH LATCH MECHANISM HAVING ROLLER PAWL ASSEMBLY

(71) Applicant: MAGNA CLOSURES INC., Newmarket (CA)

(72) Inventor: Francesco CUMBO, Newmarket (CA)

(21) Appl. No.: 19/225,256

(22) Filed: Jun. 2, 2025

Related U.S. Application Data
(60) Provisional application No. 63/657,139, filed on Jun. 7, 2024.

(51) Int. Cl. E05B 77/04; E05B 85/26

(52) U.S. Cl. CPC E05B 77/04; E05B 85/26

(57) ABSTRACT

A latch assembly for a vehicle closure member including a frame plate, a ratchet rotatably mounted to the frame plate, a pawl assembly rotatably mounted to the frame plate for holding the ratchet in a primary striker capture position and for releasing the ratchet to allow the ratchet to rotate toward a striker releasing position during a non-crash state of the latch assembly, and a secondary pawl rotatably mounted to the frame plate for holding the ratchet in a secondary striker capture position during a crash state of the latch assembly.

### CROSS-REFERENCE TO RELATED APPLICATIONS

This application claims the benefit of U.S. Provisional Application Ser. No. 63/657,139, filed Jun. 7, 2024, which is incorporated herein by way of reference in its entirety.

### FIELD

The present disclosure relates generally to automotive latches for closure panels.

### BACKGROUND

This section provides background information related to automotive door latches and is not necessarily prior art to the inventive concepts associated with the present disclosure.

Motor vehicle closure panels, such as, for example, passenger side doors, are typically mounted by upper and lower door hinges to the vehicle body for swinging movement about a generally vertical pivot axis. Each side door hinge typically includes a door hinge strap connected to the side door, a body hinge strap connected to the vehicle body, and a pivot pin arranged to pivotably connect the door hinge strap to the body hinge strap and define the pivot axis. Such passenger side doors, also referred to as swing doors, have recognized issues such as, for example, undesirable high door latch release effort, which can be caused, at least in part, by high static frictional forces and dynamic frictional forces generated between a ratchet and pawl of the latch during relative movement between the ratchet and pawl. Current mechanisms for reducing friction between the ratchet and pawl can include a double pawl configuration, special low friction lubrication, and/or low friction plating. Although the aforementioned mechanisms can help in reducing static and dynamic friction, there remain disadvantages associated therewith, such as a relatively short life of lubrication and plating due to being worn away, as well as undesirable manufacturing complexities and cost associate therewith. Beyond the aforementioned issues, there remains a desire to increase the reduction of friction between a ratchet and pawl beyond the reduction of friction provided by known mechanisms, and to maintain the reduced friction over the useful life of the latch assembly.

In view of the above, there remains a need to develop a closure latch assembly which addresses and overcomes at least those disadvantages discussed above.

### SUMMARY

This section provides a general summary of the present disclosure and is not a comprehensive disclosure of its full scope or all of its features, aspects and objectives.

In accordance with an aspect of the present disclosure, provided is a latch assembly for a vehicle closure member, including a frame plate, a ratchet rotatably mounted to the frame plate, a pawl assembly rotatably mounted to the frame plate for holding the ratchet in a primary striker capture position and for releasing the ratchet to allow the ratchet to rotate towards an striker releasing position during a non-crash state of the latch assembly, and a secondary pawl rotatably mounted to the frame plate for holding the ratchet in a secondary striker capture position during a crash state of the latch assembly.

In accordance with another aspect of the latch assembly, the pawl assembly comprising a primary pawl and a rolling member rotatably between the primary pawl and the ratchet.

In accordance with another aspect of the latch assembly, the rolling member lies within a plane of a main body of the ratchet for engagement with a closing notch of the ratchet while the ratchet is in the primary striker capture position, and the secondary pawl lies within a plane in side-by-side, parallel relation with the plane of the main body of the ratchet, wherein the secondary pawl is configured to engage a ratchet rivet extending laterally outwardly from the main body of the ratchet to hold the ratchet in the secondary striker capture position during the crash state of the latch assembly with the rolling member disengaged from the closing notch.

In accordance with another aspect of the latch assembly, the secondary pawl is configured for holding the ratchet in a secondary striker capture position during the non-crash state of the latch assembly.

In accordance with another aspect of the latch assembly, the secondary pawl is configured for holding the ratchet in a secondary striker capture position after the ratchet has rotated away from the primary striker capture position in response to the pawl assembly releasing the ratchet in response to a crash opening force applied to the latch assembly.

In accordance with another aspect of the latch assembly, the secondary pawl is configured for holding the ratchet in a secondary striker capture position during the crash state of the latch assembly with the primary pawl assembly in the primary striker capture position.

In accordance with another aspect of the latch assembly, the pawl assembly has a primary pawl pivotably supported for rotation about a primary pawl pivot post for engagement with a closing notch of the ratchet while the ratchet is in the primary striker capture position and the secondary pawl is pivotally supported for rotation about a secondary pawl pivot post spaced from the primary pawl pivot post.

In accordance with another aspect of the latch assembly, the secondary pawl has a first arm and a second arm extending outwardly from the secondary pawl pivot post in inclined relation relative to one another, the first arm arranged for engagement with a release lever and the second arm arranged for engagement with the ratchet during the crash state of the latch assembly.

In accordance with another aspect of the latch assembly, the ratchet has a ratchet rivet extending laterally outwardly from a main body of the ratchet, the second arm arranged in alignment to engage the ratchet rivet during the crash state of the latch assembly to prevent the ratchet from rotating to the striker releasing position.

In accordance with another aspect of the latch assembly, the second arm is arranged to pivot out from alignment with the ratchet rivet in response to the release lever driving the first arm and rotating the secondary pawl about the secondary pawl pivot post during the non-crash state of the latch assembly to allow the ratchet to move to the striker releasing position.

In accordance with another aspect of the latch assembly, the second arm is arranged out from alignment with the closing notch of the ratchet.

In accordance with another aspect of the latch assembly, the release lever has a first release lever arm and a second release lever arm extending away from one another from the primary pawl pivot post, the first release lever arm arranged to engage the first arm of the secondary pawl to rotate the secondary pawl about the secondary pawl pivot post during the non-crash state of the latch assembly to allow the ratchet to move to the striker releasing position during the non-crash state and the second release lever arm arranged to engage a pawl pin extending outwardly a primary pawl of the pawl assembly to release the ratchet from the primary striker capture position to allow the ratchet to rotate toward a striker releasing position during the non-crash state of the latch assembly.

In accordance with another aspect of the latch assembly, the ratchet has a guide channel configured for receipt of the striker with a first nose located on one side of the guide channel and a second nose located on an opposite side of the guide channel, wherein an out-of-plane deformation of the first nose of the ratchet from a plane of a main body of the ratchet, caused by displaced movement of the striker during the crash state of the latch assembly, into alignment with a secondary blocking surface of the secondary pawl provided by a central hub of the secondary pawl centered about a secondary pawl pivot post, prevents movement of the ratchet to the striker releasing position.

In accordance with another aspect of the disclosure, a latch assembly includes a frame plate and a ratchet rotatably mounted to the frame plate. The ratchet has a planar main body defining a guide channel configured for receipt of a striker with a first nose located on one side of the guide channel and a second nose located on an opposite side of the guide channel, the second nose having a closing notch and a ratchet rivet extending outwardly from the planar main body. Further, a pawl assembly is rotatably mounted to the frame plate for engaging the closing notch and holding the ratchet in a primary striker capture position, whereat the striker is captured in the guide channel and prevented from being removed from the ratchet, and for moving out of engagement from the closing notch to allow the ratchet to rotate to a striker releasing position, whereat the striker can be removed from the guide channel, during a non-crash state of the latch assembly. Further yet, a secondary pawl is rotatably mounted to the frame plate for rotation about a secondary pawl pivot post for engaging the ratchet rivet and holding the ratchet in a secondary striker capture position, whereat the striker is captured in the guide channel and prevented from being removed from the ratchet, during a crash state of the latch assembly.

In accordance with another aspect of the latch assembly, the secondary pawl has a first arm and a second arm extending outwardly from the secondary pawl pivot post in inclined relation relative to one another, the first arm arranged for engagement with a release lever and the second arm arranged for engagement with the ratchet rivet during the crash state of the latch assembly.

In accordance with another aspect of the latch assembly, the second arm is arranged out from alignment with the closing notch of the ratchet and wherein the second arm is configured to pivot out from alignment with the ratchet rivet in response to the release lever driving the first arm and rotating the secondary pawl about the secondary pawl pivot post during the non-crash state of the latch assembly to allow the ratchet to move to the striker releasing position.

In accordance with another aspect of the latch assembly, the planar main body of the ratchet is arranged to pivot in a first plane and the secondary pawl has a planar main body arranged to pivot in a second plane, the first plane and the second planar being spaced from one another in parallel relation.

In accordance with another aspect of the latch assembly, an out-of-plane deformation of the first nose of the ratchet from the plane of the main body of the ratchet, caused by displacement of the striker during the crash state of the latch assembly, into alignment for engagement with a central hub of the secondary pawl centered about the secondary pawl pivot post, prevents movement of the ratchet to the striker releasing position.

### BRIEF DESCRIPTION OF THE DRAWINGS

These and other aspects, features, and advantages of the present disclosure will be readily appreciated, as the same becomes better understood by reference to the following detailed description when considered in connection with the accompanying drawings wherein:

FIG. 1 is a partial perspective view of a motor vehicle illustrating a passenger swing door equipped with a closure latch assembly in accordance with one aspect the present disclosure;

FIG. 2 is a front side view of a closure latch assembly in a primary latched state in accordance with one aspect of the disclosure configured for use in the passenger swing door of FIG. 1;

FIG. 3 is a front side view of the closure latch assembly of FIG. 2, showing a release lever removed for illustrating a pawl assembly;

FIG. 4 is a view of the latch assembly of FIG. 1 shown in a partially released state;

FIG. 5 is a view of the latch assembly of FIG. 1 shown in a fully released state;

FIG. 6 is a view of the latch assembly of FIG. 1 shown in a safety-released state;

FIG. 7 is a view of the latch assembly of FIG. 1 shown in a safety-released state; and

FIG. 8 is a view of the latch assembly of FIG. 1 provided with a dual-plate configuration in accordance with an illustrative embodiment.

### DETAILED DESCRIPTION OF EXAMPLE EMBODIMENTS

A series of example embodiments of a closure latch assembly for use in a motor vehicle closure system will now be described more fully with reference to the accompanying drawings. To this end, the example embodiments of the closure latch assembly is provided so that this disclosure will be thorough, and will fully convey its intended scope to those who are skilled in the art. Accordingly, numerous specific details are set forth, such as examples of specific components, devices, and methods, to provide a thorough understanding of a particular embodiment of the present disclosure. However, it will be apparent to those skilled in the art that specific details need not be employed, that the example embodiments may be embodied in many different forms, and that the example embodiments should not be construed to limit the scope of the present disclosure. In some parts of the example embodiments, well-known processes, well-known device structures, and well-known technologies are not described in detail.

In the following detailed description, the expression “closure latch assembly” will be used to generally indicate any latch mechanism adapted for use with a vehicle closure panel. Additionally, the expression “closure panel” will be used to indicate any element mounted to a vehicle body portion of a motor vehicle and moveable between an open position and at least one closed position, respectively opening and closing an access to an inner compartment of the motor vehicle, and therefore includes, without limitations, decklids, tailgates, liftgates, bonnet lids, and sunroofs in addition to the sliding or pivoting passenger doors of the motor vehicle to which the following description will make explicit reference, purely by way of example.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

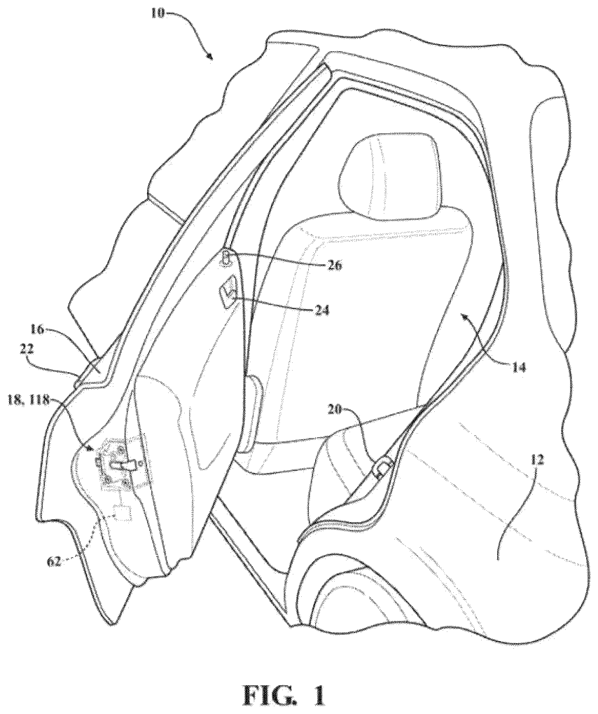

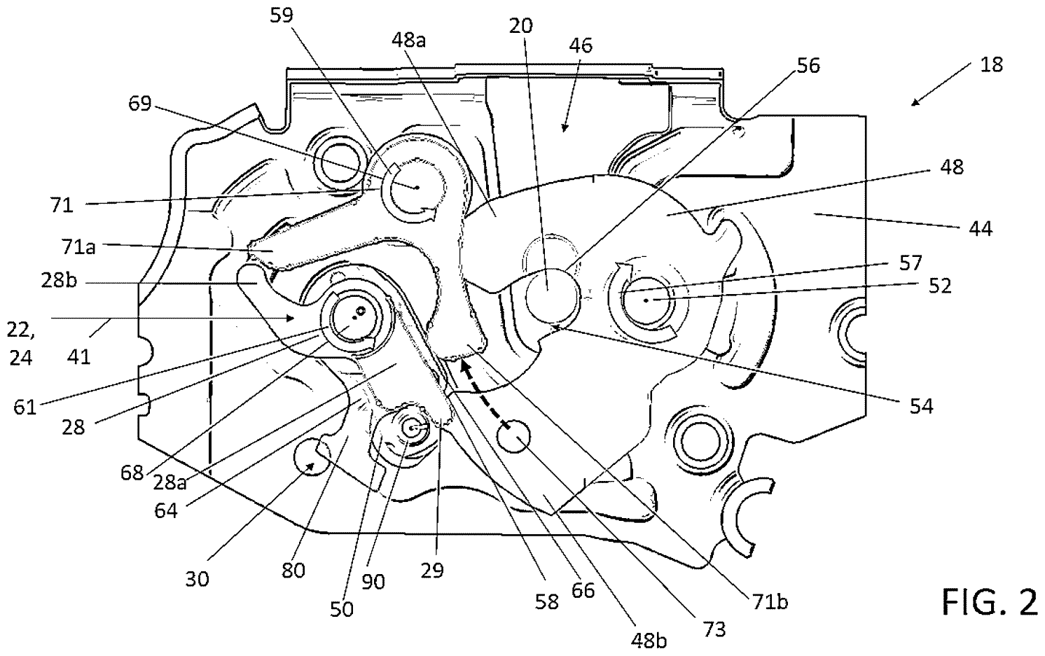

Referring initially to FIG. 1 of the drawings, a motor vehicle 10 is shown to include a vehicle body 12 defining an opening 14 to an interior passenger compartment. A closure panel 16, for example a vehicle door, shown as a swing door 16, is illustratively shown pivotably mounted to vehicle body 12 for movement between an open position (shown) and a fully-closed position to respectively open and close opening 14. A closure latch assembly 18 is shown secured to closure panel 16 adjacent to an edge portion thereof and includes a ratchet 48 (see FIG. 2) that is releasably engageable with a striker 20 fixedly secured to a recessed edge portion of vehicle body 12. As will be detailed, closure latch assembly 18 is operable to engage striker 20 and releasably hold closure panel 16 in its fully-closed position. An outside handle 22 and an inside handle 24 are provided for selectively actuating a primary pawl, referred to hereafter as pawl 50, of closure latch assembly 18 of to release striker 20 from the ratchet 48 and permit subsequent movement of closure panel 16 to its open position. An optional lock knob 26 provides a visual indication of the locked state of closure latch assembly 18 and which may also be operable to mechanically change the locked/unlocked state of closure latch assembly 18. For purpose of clarity and functional association with motor vehicle 10, the closure panel is hereinafter referred to as vehicle door 16.

A detailed description of a non-limiting example of closure latch assembly 18, constructed in accordance with the teachings of the present disclosure, will now be provided. In general, closure latch assembly 18 includes latch mechanism having a pawl assembly 30 and ratchet 48, and also includes a release lever 28 mechanically or electromechanically coupled to the outside and/or inside handle(s) 22, 24. The pawl assembly 30 is a roller pawl assembly having a bearing or rolling element positioned between the pawl 50 and the ratchet 48, now referred to hereafter as the pawl assembly 30 moveable by release lever 28 operably connected to handles 22,24 via a connective member 41, such as a rod, cable or the like. The pawl assembly 30 may be illustratively configured using the teachings of US Patent No. U.S. Pat. No. 11,512,509B2 titled “Closure latch assembly with latch mechanism having roller pawl assembly”, the entire contents of which are incorporated by reference herein. It will be readily appreciated by one skilled in the art that the above components can be mounted to, including pivotably mounted to and within a housing, sometimes referred to as frame plate 44, suitably shaped for the intended vehicle application, with a housing cover or frame plate cover supporting and enclosing the above-noted mechanisms.

Frame plate 44 is a rigid component, shown in the non-limiting embodiment as being configured to be fixedly secured to edge portion of vehicle door 16 and which defines an entry aperture 46, sometimes referred to as fishmouth, through which striker 20 travels upon movement of vehicle door 16 relative to vehicle body 12. Latch mechanism is shown, in this non-limiting example, as having a single ratchet and pawl arrangement including ratchet 48 and pawl 50. Ratchet 48 is supported for rotational, pivotable movement relative to frame plate 44 via a ratchet pivot pin 52. Ratchet 48 is configured to include a contoured guide channel 54 which terminates in a striker capture pocket 56, and a closing surface, also referred to as a closing notch 58. A ratchet biasing member 57, is adapted to normally bias ratchet 48 to rotate about ratchet pivot pin 52 in a first, opening or “releasing” direction (i.e. clockwise in FIG. 2) toward a striker releasing position.

Movement of the closure panel 16 (e.g. between the open and closed panel positions) can be electronically and/or manually operated by an electronic latch controller 62, where power assisted closure panels 16 can be found on minivans, high-end cars, or sport utility vehicles (SUVs) and the like. As such, it is recognized that movement of the closure panel 16 can be manual or power assisted (e.g. using electronic latch controller 62) during operation of the closure panel 16 at, for example: between fully closed (e.g. locked or latched) and fully open (e.g. unlocked or unlatched); between locked/latched and partially open (e.g. unlocked or unlatched); and/or between partially open (e.g. unlocked or unlatched) and fully open (e.g. unlocked or unlatched).

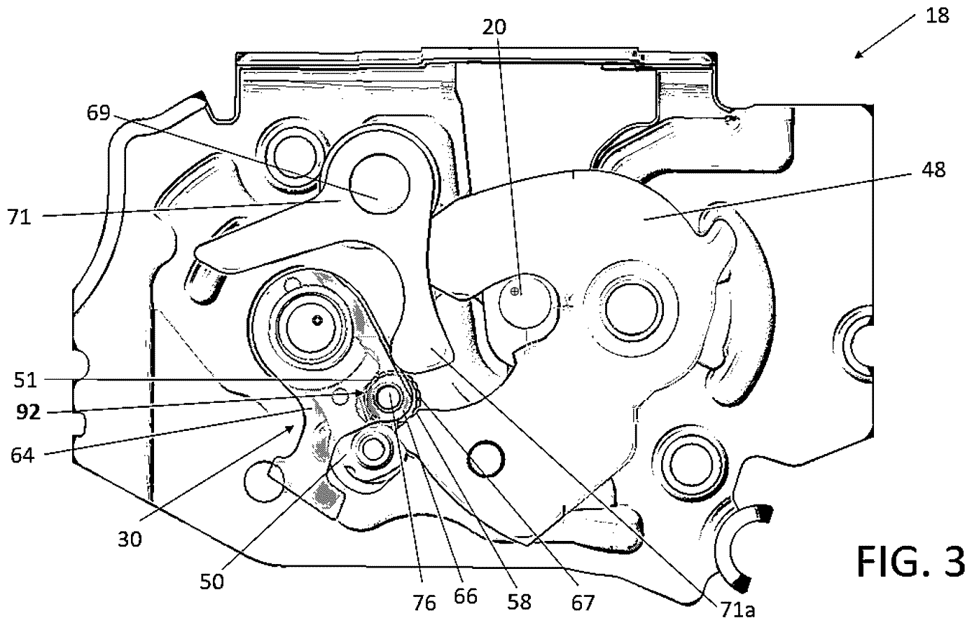

As best shown in FIGS. 2 and 3, the pawl assembly 30 includes the pawl 50, a carrier member, also referred to as carrier plate, and referred to hereafter simply as carrier 64, a rolling member 66, referred to hereafter as roller 66, and a primary pawl pivot post 68, also referred to as pawl support member, pawl pin or pawl rivet. The pawl rivet 68 is fixed, such as to the frame plate 44, with carrier plate 64 and a first end region 88a of pawl 50 being configured for selective rotation about a central longitudinal axis of the pawl rivet 68.

The carrier 64, in a non-limiting embodiment, has a generally planar main body surface positioned in a plane in side-by-side, laterally adjacent relation with a plane of a main body of the pawl 50, for rotation about the pawl rivet 68. The carrier 64 has a roller support member 76, referred to hereafter as roller pin or support pin 76, fixed thereto. Support pin 76 extends laterally outwardly in cantilevered fashion from the generally planar body of the carrier 64 in parallel relation with the central longitudinal axis of the pawl rivet 68. Support pin 76 is configured for receipt of roller 66 thereon, wherein support pin 76 is sized for a close, minimum play loose fit within a through bore of roller 66, such that roller 66 is free to rotate about support pin 76. Roller 66 can be retained on support pin 76 via any suitable mechanism that retains the ability of roller 66 to rotate on support pin 76, such as a C-clip or other type of fastening device or mechanism, including plastically deforming an end portion of support pin 76 to capture the roller 66 between the upset end portion and a flange of planar main body of carrier 64, or otherwise. The main body of carrier 64 further includes an elongate extension 80, also referred to as arm 80. Arm 80 extends outwardly and away from the first end region 88a of pawl 50 and away from support pin 76 of carrier 64 to form an arcuate pocket recessed in the main body of the carrier 64.

The pawl 50 has a driven lug, also referred to as pawl pin 90, arranged to operable engagement with tab 29 of release lever 28. Pawl pin 90 is fixed to pawl 50 and extends laterally into the plane of the carrier 64, wherein pawl pin 90 extends parallel with axis of pawl rivet 68 upon pawl 50 being disposed on pawl rivet 68 and parallel with axis of roller support member 76. Pawl pin 90 is disposed within and through the pocket 82 of carrier 64, wherein a predetermined degree of free pivotal rotation of pawl pin 90 within pocket 82 is provided, before the pawl pin 90 contacts a surface defining pocket 82 of the carrier 64. Pawl 50 has an arcuate recessed pocket 92 adjacent a second end region 88b of pawl 50. Recessed pocket 92 is contoured for close mating receipt of roller 66 therein (FIG. 3), and is delimited on one side by a raised lip or shoulder.

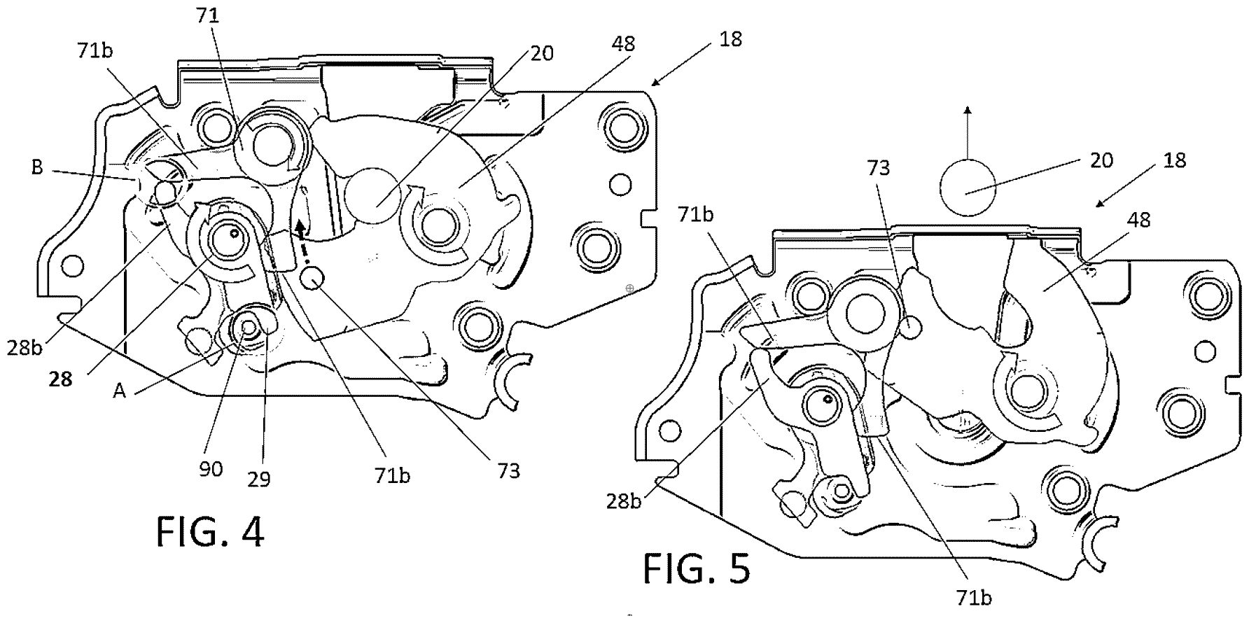

Latch mechanism can be maintained in a locked/latched state or position, such as shown in FIGS. 2, 3, and in an unlocked state or position, such as shown in FIGS. 4-5. While in the locked state, the tab 29 of release lever 28 is maintained out of reach of the pawl pin 90, and thus, any movement imparted on the release lever 28 via actuation of handle 22, 24 does not result in movement of pawl 50 or carrier 80, and thus, the latch mechanism 19 remains in the latched state.

The roller 66 is shown as having a cylindrical outer surface 67 (FIG. 3) configured for rolling engagement with the corresponding surfaces of the ratchet 48 and pawl 50, though any desired contour shape of the outer surface 67 is contemplated herein. For example, the outer surface 67 could be spherical, elliptical, or some other arcuate shape. Further, the outer surface 67 could be textured (e.g. roughened), coated with a suitable bearing grade material, polished or otherwise. In addition, the roller 66 is shown as being a monolithic piece of material journaled directly on roller pin 76; however, it is contemplated that roller 66 could be provided as a roller bearing having a plurality of rolling elements, including balls, roller needles, or otherwise. A single rolling element, such as a sphere, or cylinder, or ball as a non-limiting example only, may also be provided. Accordingly, any suitable low-friction bearing is contemplated herein.

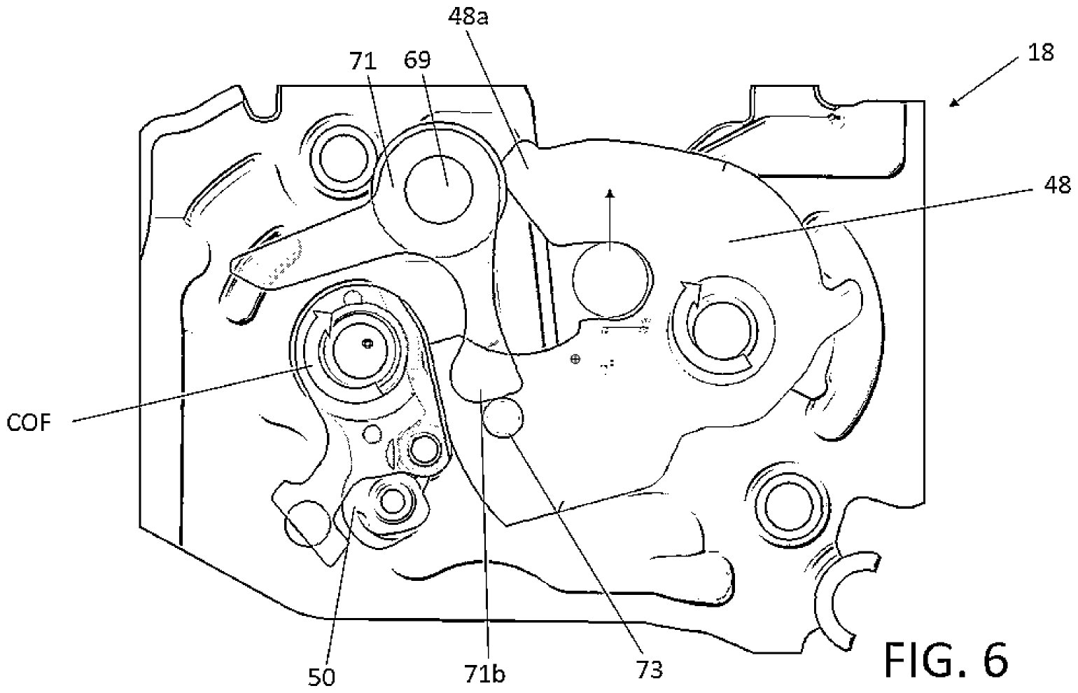

Latch assembly 18 is further configured having a secondary pawl 71 pivotally supported about a secondary pawl pivot post 69 spaced from the primary pawl pivot post 68. Secondary pawl 71 has a first arm 71a and a second arm 71b extending in inclined relation relative to one another outwardly from secondary pawl pivot post 69. Secondary pawl 71 may be biased rotatably toward the ratchet 48 by a secondary pawl biasing member, such as a secondary pawl biasing spring 59, to cause the secondary pawl 71 to be in a normally blocking position for engagement with the ratchet 48 when the ratchet 48 is in the primary striker capture position and the pawl assembly 30 is in the primary ratchet holding position in engagement with the closing notch 58 of ratchet 48 (see FIG. 2). As indicated by dashed arrow of FIG. 2, a rotation of the ratchet 48 away from the primary striker capture position will cause a ratchet lug, also referred to as ratchet rivet 73, fixed to and extending laterally outward from a planar face of ratchet 48, to forcibly engage secondary pawl 71, and for example the secondary pawl second arm 71b already aligned with the ratchet rivet 73, to block further unintended rotation of the ratchet 48 toward the striker releasing position. Accordingly, secondary pawl 71 is configured to engage and hold the ratchet 48 in a secondary striker capture position (see FIG. 6), while the primary pawl 50 is inadvertently and unintentionally released from the closing notch 58, such as in a crash condition, to prevent the ratchet 48 from moving to the striker releasing position, thereby preventing striker 20 from being inadvertently fully released from the ratchet 48. It is to be understood that the second arm 71b is arranged out from alignment with the closing notch 58 of the ratchet 48, such that secondary pawl 71 does not interact with closing notch 58, which lies and pivots within the plane of a main planar body of ratchet 58. Rather, second arm 71b lies in a plane of a main body of the secondary pawl 71 which is laterally offset from the plane of the primary pawl assembly 30 and rolling member 66 thereof for alignment with ratchet rivet 73, which extends outwardly from the plane in which main body of ratchet 48 and closing notch 58 lie. As such, the planar main body of the ratchet 48 is arranged to pivot in a first plane and the secondary pawl 71 has a planar main body arranged to pivot in a second plane, with the first plane and the second plane being offset and spaced from one another in parallel, adjacent relation. Accordingly, during a normal operation, as ratchet 48 is moving from the primary striker capture position to the striker releasing position, closing notch 58 moves freely past the second arm 71b without impact therewith as the secondary pawl 71 and second arm 71b thereof is being rotated by second release lever arm 28b. However, the second arm 71b is arranged in alignment with the ratchet rivet 73 for engagement with the ratchet rivet 73 absent the first arm 71a of the secondary pawl 71 being intentionally pivoted by the release lever 28. Secondary pawl 71 is configured to engage and hold the ratchet 48 in the secondary latched position during two latching states: (a) during a normal closing state in which the striker 20 is being returned in the fishmouth 46 causing the ratchet 48 to rotate toward the primary striker capture position (fully closed position). In the event the ratchet 48, as rotated by the striker 20, is not returned fully to the primary striker capture position, the ratchet 48 may be prevented from fully opening by the secondary pawl 71 once the ratchet rivet 73 has moved beyond and traversed the entirety the length of second arm 71b in the closing direction, whereupon the end of the second arm 71b returns into alignment with the ratchet rivet 73 via the bias imparted by secondary pawl biasing member 59; and (b) during a crash condition in which the pawl assembly 30 has been caused to be unintentionally and undesirably moved from the ratchet holding position to the ratchet releasing position out of engagement from closing notch 58, whereupon the rotation of the ratchet 48 to the striker release position of FIG. 5 is prevented by the ratchet rivet 73 moving into engagement with the secondary pawl 71 e.g. end of second arm 71b (FIG. 6). Since the roller 66 of the pawl assembly 30 advantageously reduces the manual and/or electrical release efforts during a normal non-crash condition, during non-normal, or a crash condition of the latch assembly 18, it is desirable to prevent the ratchet 48 from fully releasing the striker 20 when crash originating inertia forces act on the latch assembly 18 causing the pawl 50 to disengage from the ratchet 48, now occurring at lower inertia force thresholds compared to latch assemblies without a roller element 66 due to the improved reduction in release efforts from use of the roller element 66. As shown in FIG. 6, when a crash opening force (COF) acting on the pawl assembly 30 or other component of a release chain upstream of pawl assembly 30 (for example due to the mass of a lever or a handle) causes the pawl 50 to move away from the primary ratchet holding position, the ratchet 48 may be allowed to rotate until the secondary pawl 71 blocks further rotation of the ratchet 48 when the second arm 71b engages the ratchet rivet 73. Accordingly, unintended movement of primary pawl 50 from its primary ratchet holding position to its ratchet releasing position causes ratchet 48 to rotate via the ratchet biasing member 57 toward the striker releasing position, whereupon ratchet rivet 73 is brought into engagement with an end of the second arm 71b of secondary pawl 71, thereby maintaining ratchet 48 in its secondary striker capture position to prevent unwanted, unintended opening of the vehicle door 16.

In normal use, such as during a non-crash condition, such as for example during a non-crash condition, when the swing door 16 is in a fully-closed position, the latch mechanism is as appears in FIG. 2, with the roller 66 disposed in seated abutment with the closing notch 58 of ratchet 48 and in seated abutment with the pawl 50 within recessed pocket 92. When in the unlocked state, upon intended actuation release lever 28 (FIG. 4, 5), such as via actuation of one of the handles 22, 24, by way of example and without limitation, an end protrusion, also referred to as tab 29, on a first release lever arm 28a of release lever 28 is brought into engagement with the pawl pin 90 as indicated in FIG. 4 by circle A, and as such, pawl 50 is rotatably driven by pawl pin 90 along with rotation of release arm 28 against a bias of a pawl biasing spring member 61, such that rotation of release lever 28 causes conjoint rotation of pawl 50. Accordingly, driven actuation of the release lever 28 will drive tab 29 into contact with the pawl pin 90 to impart a force to drive the rotation of the pawl 50 from its ratchet holding position to its ratchet releasing position as the release lever 28 is being driven further causing pure rolling motion of roller 66 off of the ratchet closing notch 58. With the rolling motion of roller 66 being pure rolling motion, no sliding friction is generated between ratchet 48 and roller 66 nor between pawl 50 and roller 66. At the same time or prior to the rotation of the pawl 50 by the release lever 28, release lever 28, via a second release lever arm 28b, is brought into driving contact with the first arm 71a of the secondary pawl 71 in response to actuation of connection member 41, as seen in FIG. 4 and indicated by circle B, to cause the rotational movement of the second arm 71b out of alignment with the ratchet rivet 73 such that the rotation of the ratchet 48 toward the fully opened position is unhindered by the secondary pawl 71 during a non-crash state release operation of the latch assembly 18, as shown in FIG. 5. In the non-limiting embodiment illustrated, the first release lever arm 28a and the second release lever arm 28b extend away from one another outwardly from the pawl pivot 68. Secondary pawl 71 pawl may be configured with a lower efficiency, higher friction release compared to that that of the roller pawl assembly 30 to ensure the ratchet 48 is prevented from reaching fully opened position during a crash condition.

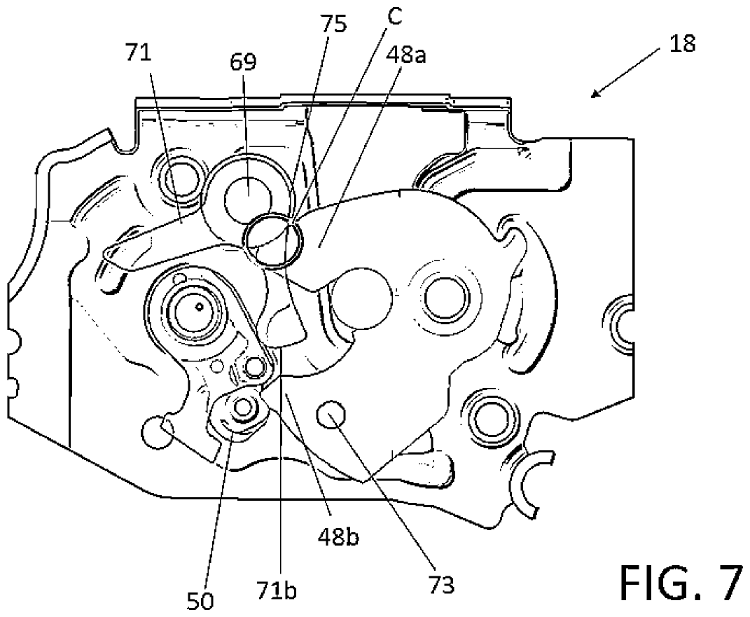

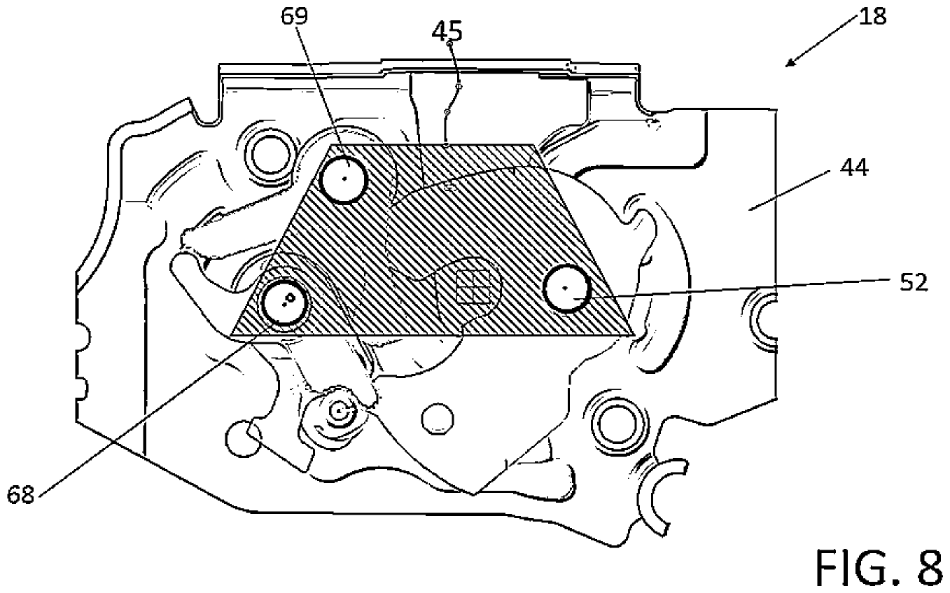

Now referring to FIG. 7, in an impact condition, also referred to as crash condition, the secondary pawl 71 is configured to further prevent rotation of the ratchet 48 toward the striker release position with the primary pawl 50 still engaged with the ratchet 48. For example an out-of-plane deformation of a first nose 48a of the ratchet 48 may occur due to displaced movement of the striker 20. First nose 48a, located on an opposite side of the guide channel 54 from closing notch 58, maybe thus moved into alignment with a secondary blocking surface of the secondary pawl 71, with secondary blocking surface provided illustratively by a central hub, also referred to as rivet 75, centered about the secondary pawl pivot post 69 to prevent the deformation of the first nose 48a, thereby preventing a release of the striker 20. Thus, rivet 75 of secondary striker 71 provides a further safety blocking feature of the ratchet 48 while the roller pawl assembly 30 remains in engagement with the closing notch 58 provided on a second nose 48b, located on an opposite side of the guide channel 54 from first nose 48a of the ratchet 48.

In view of the above disclosure, and in further view of the figures, one skilled in the art, upon viewing the entirety of the disclosure herein, will readily appreciate the minimal force required to actuate the latch mechanism 19 between the ratchet holding and releasing positions while providing a back up secondary pawl configuration 71 for non-normal impact, such as crash conditions, of the latch assembly 18. Further, the secondary striker position of the ratchet 48 is provided separate from primary striker capture position such that any self-opening of the primary pawl assembly 30 from the primary striker capture position will not cause the latch assembly 18 to open, thereby providing a redundant safe retention position at secondary striker capture position. Further, separate levers can allow to set the distance between the primary striker capture position and secondary striker capture position without compromises which may not be obtainable when a latch configuration having only a roller pawl assembly without a secondary pawl is provided due to the roller size and distance on the ratchet profile between primary and secondary ratchet notches. Furthermore, the pawls 50, 71 won't bounce during closing, thereby providing reduced closing noise. Still further, the rivet 69 of the secondary pawl 71 provides an additional anchor point between the frame plate 44 and a back plate 45 for increasing the latch strength, as shown in FIG. 8. Such a third rivet 69 may also be positioned to prevent the ratchet nose 48a deforming during pulling in Y direction (out of page in FIG. 7) and this would also contribute in increasing the latch strength.

The foregoing description of the several embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Those skilled in the art will recognize that concepts disclosed in association with the example detection system can likewise be implemented into many other systems to control one or more operations and/or functions.

1. A latch assembly, comprising:
a frame plate;
a ratchet rotatably mounted to the frame plate;
a pawl assembly rotatably mounted to the frame plate for holding the ratchet in a primary striker capture position, and for releasing the ratchet to allow the ratchet to rotate toward a striker releasing position during a non-crash state of the latch assembly; and
a secondary pawl rotatably mounted to the frame plate for holding the ratchet in a secondary striker capture position during a crash state of the latch assembly.

2. The latch assembly of claim 1, wherein the pawl assembly has a primary pawl and a rolling member rotatable between the primary pawl and the ratchet.

3. The latch assembly of claim 2, wherein the rolling member lies within a plane of a main body of the ratchet for engagement with a closing notch of the ratchet while the ratchet is in the primary striker capture position, and the secondary pawl lies within a plane in side-by-side, parallel relation with the plane of the main body of the ratchet, wherein the secondary pawl is configured to engage a ratchet rivet extending laterally outwardly from the main body of the ratchet to hold the ratchet in the secondary striker capture position during the crash state of the latch assembly with the rolling member disengaged from the closing notch.

4. The latch assembly of claim 1, wherein the secondary pawl is configured to hold the ratchet in the secondary striker capture position during the non-crash state of the latch assembly.

5. The latch assembly of claim 4, wherein the secondary pawl is configured to hold the ratchet in the secondary striker capture position after the ratchet has rotated away from the primary striker capture position in response to the pawl assembly releasing the ratchet under a crash opening force applied to the latch assembly.

6. The latch assembly of claim 1, wherein the pawl assembly has a primary pawl pivotably supported for rotation about a primary pawl pivot post for engagement with a closing notch of the ratchet while the ratchet is in the primary striker capture position and the secondary pawl is pivotally supported for rotation about a secondary pawl pivot post spaced from the primary pawl pivot post.

7. The latch assembly of claim 6, wherein the secondary pawl has a first arm and a second arm extending outwardly from the secondary pawl pivot post in inclined relation relative to one another, the first arm arranged for engagement with a release lever and the second arm arranged for engagement with the ratchet during the crash state of the latch assembly.

8. The latch assembly of claim 7, wherein the ratchet has a ratchet rivet extending laterally outwardly from a main body of the ratchet, the second arm arranged in alignment to engage the ratchet rivet during the crash state of the latch assembly to prevent the ratchet from rotating to the striker releasing position.

9. The latch assembly of claim 8, wherein the second arm is arranged to pivot out from alignment with the ratchet rivet in response to the release lever driving the first arm and rotating the secondary pawl about the secondary pawl pivot post during the non-crash state of the latch assembly to allow the ratchet to move to the striker releasing position.

10. The latch assembly of claim 8, wherein the second arm is arranged out from alignment with the closing notch of the ratchet.

11. latch assembly of claim 7, wherein the release lever has a first release lever arm and a second release lever arm extending away from one another from the primary pawl pivot post, the first release lever arm arranged to engage the first arm of the secondary pawl to rotate the secondary pawl about the secondary pawl pivot post during the non-crash state of the latch assembly to allow the ratchet to move to the striker releasing position during the non-crash state and the second release lever arm arranged to engage a pawl pin extending outwardly a primary pawl of the pawl assembly to release the ratchet from the primary striker capture position to allow the ratchet to rotate toward a striker releasing position during the non-crash state of the latch assembly.

12. latch assembly of claim 1, wherein the ratchet has a guide channel configured for receipt of the striker with a first nose located on one side of the guide channel and a second nose located on an opposite side of the guide channel, wherein an out-of-plane deformation of the first nose of the ratchet from a plane of a main body of the ratchet, caused by displaced movement of the striker during the crash state of the latch assembly, into alignment with a secondary blocking surface of the secondary pawl provided by a central hub of the secondary pawl centered about a secondary pawl pivot post, prevents movement of the ratchet to the striker releasing position.

13. A latch assembly, comprising:
a frame plate;
a ratchet rotatably mounted to the frame plate, the ratchet having a planar main body defining a guide channel configured for receipt of a striker with a first nose located on one side of the guide channel and a second nose located on an opposite side of the guide channel, the second nose having a closing notch and a ratchet rivet extending outwardly from the planar main body;
a pawl assembly rotatably mounted to the frame plate for rotation about a primary pawl pivot post for engaging the closing notch and holding the ratchet in a primary striker capture position, whereat the striker is captured in the guide channel and prevented from being removed from the ratchet, and for moving out of engagement from the closing notch to allow the ratchet to rotate to a striker releasing position, whereat the striker can be removed from the guide channel, during a normal release of the pawl assembly from the closing notch of the ratchet; and
a secondary pawl rotatably mounted to the frame plate for rotation about a secondary pawl pivot post for engaging the ratchet rivet and holding the ratchet in a secondary striker capture position, whereat the striker is captured in the guide channel and prevented from being removed from the ratchet, during an inadvertent release of the pawl assembly from the closing notch of the ratchet.

14. The latch assembly of claim 13, wherein the secondary pawl has a first arm and a second arm extending outwardly from the secondary pawl pivot post in inclined relation relative to one another, the first arm arranged for engagement with a release lever and the second arm arranged for engagement with the ratchet rivet during the inadvertent release of the pawl assembly from the closing notch of the ratchet.

15. The latch assembly of claim 14, wherein the second arm is arranged in alignment with the ratchet rivet for engagement with the ratchet rivet absent the first arm being intentionally pivoted by the release lever.

16. The latch assembly of claim 14, wherein the second arm is arranged out from alignment with the closing notch of the ratchet and wherein the second arm is configured to pivot out from alignment with the ratchet rivet in response to the release lever driving the first arm and rotating the secondary pawl about the secondary pawl pivot post during the normal release of the pawl assembly from the closing notch of the ratchet to allow the ratchet to move to the striker releasing position.

17. The latch assembly of claim 16, wherein the planar main body of the ratchet is arranged to pivot in a first plane and the secondary pawl has a planar main body arranged to pivot in a second plane, the first plane and the second planar being spaced from one another in parallel relation.

18. The latch assembly of claim 17, wherein an out-of-plane deformation of the first nose of the ratchet from the plane of the main body of the ratchet, caused by displacement of the striker during a crash state of the latch assembly, into alignment for engagement with a central hub of the secondary pawl centered about the secondary pawl pivot post, prevents movement of the ratchet to the striker releasing position.

19. The latch assembly of claim 13, wherein the secondary pawl is configured to hold the ratchet in the secondary striker capture position after the ratchet has rotated away from the primary striker capture position in response to the pawl assembly releasing the ratchet under a crash opening force applied to the latch assembly.

20. The latch assembly of claim 13, wherein the pawl assembly has a roller arranged for rolling engagement with the closing notch of the ratchet while the ratchet is in the primary striker capture position.
